(19) United States
(12) Patent Application Publication
(10) Pub. No.: US 2010/0089734 A1
(43) Pub. Date: Apr. 15, 2010

(54) Switch-on Energy Store Apparatus

(75) Inventor: Karsten Freundt, Falkensee (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/063,489

(22) PCT Filed: Aug. 10, 2005
(86) PCT No.: PCT/DE05/01439

§ 371 Date: Feb. 11, 2008

(51) Int. Cl. H01H 5/00

(52) U.S. Cl. 200/400

(57) ABSTRACT

In order to form a switch-on energy storage apparatus for a circuit breaker, wherein a switch-on energy storage device is held at a first end and is connected to a cam of a tensioning apparatus at a second end, with which tensioning apparatus means interact which limit a return movement. The switch-on energy storage apparatus has a simple and cost-effective design. The means have a ratchet mechanism arranged at the first end of the switch-on energy storage device.

The invention relates to a switch-on energy store apparatus for a circuit breaker, a switch-on energy store being held at a first end and being connected to an eccentric of a tensioning apparatus at a second end, with which tensioning apparatus return movement-limiting means interact.

Such a switch-on energy store apparatus for a circuit breaker is known from DE 195 03 679 C1. A switch-on spring as the switch-on energy store is fixed at its first end and at its second end is connected to an eccentric, which is arranged on a tensioning and switching shaft. In a tensioning apparatus for the switch-on spring, a return block is formed as a return movement-limiting means; the return block has stop elements, which are arranged on a bush of a lifting shaft and on a wall of the tensioning apparatus, and a free-running bearing. During a tensioning operation, in this case the bush is decoupled from the lifting shaft via the free-running bearing. After a switch-on operation of the circuit breaker, during which the energy stored in the switch-on spring is used for rotating the switching shaft, the movement direction of the switching shaft and of the end of the switch-on spring can be reversed as a result of the movement energy. During such a reversal, the bush is rotated by the free-running bearing until the stop element, which is arranged on the bush, bears against the stop element arranged on the wall. If the two stop elements are in contact with one another, a further movement is prevented. Such a free-running bearing is a precision part and is therefore very cost-intensive.

The object of the present invention is to develop a switch-on energy store of the type mentioned at the outset which makes a simple and cost-effective design possible.

This object is achieved by virtue of the fact that, according to the invention, the means have a catch mechanism, which is arranged at the first end of the switch-on energy store. Such an arrangement is advantageously simple, cost-effective and at the same time low in wear because a return movement of the switch-on energy store is limited or prevented merely by the catch mechanism, which is arranged at the first end of the switch-on energy store.

In an expedient development, the means contain a guide part, which triggers the catch mechanism, by means of which the first end of the switch-on energy store is mounted movably on a fixed spindle by means of a slot, which is formed in the guide part, and which is connected to the second end of the switch-on energy store. It is advantageous with such an arrangement that, owing to the eccentrically mounted second end of the switch-on energy store and the guide part, which is mounted in a slot, a movement path of the guide part with respect to its free end during a switch-on operation differs from a movement path after the switch-on operation, with the result that, with the catch mechanism, firstly a tensioning of the switch-on energy store takes place and secondly a return movement is limited.

In a preferred embodiment, the catch mechanism has a catch, which is capable of moving rotatably about the fixed spindle between a first and a second position and on which a spring element acts. With such a catch, the catch mechanism can have a simple design.

In a preferred embodiment, the fixed spindle and the spring element are held on a fastening element. In such an arrangement, the catch can be swiveled about the spindle between its first and its second position by means of the spring element in a simple manner.

In an expedient configuration, a stop element, which interacts with a tensioning cutout on the catch, is provided on the guide part. As a result of the arrangement of the stop element on the guide part and the interaction with the tensioning cutout, a simple possible way of deflecting the catch out of its first position into its second position is realized.

In a further development, the catch has a checking cutout. In the event of a return movement of the switch-on energy store after a switch-on operation, the stop element engages in the checking cutout, with the result that a return movement limitation is formed in a simple and effective manner.

The invention will be explained in more detail in the text which follows using the drawings and an exemplary embodiment with reference to the figures, in which:

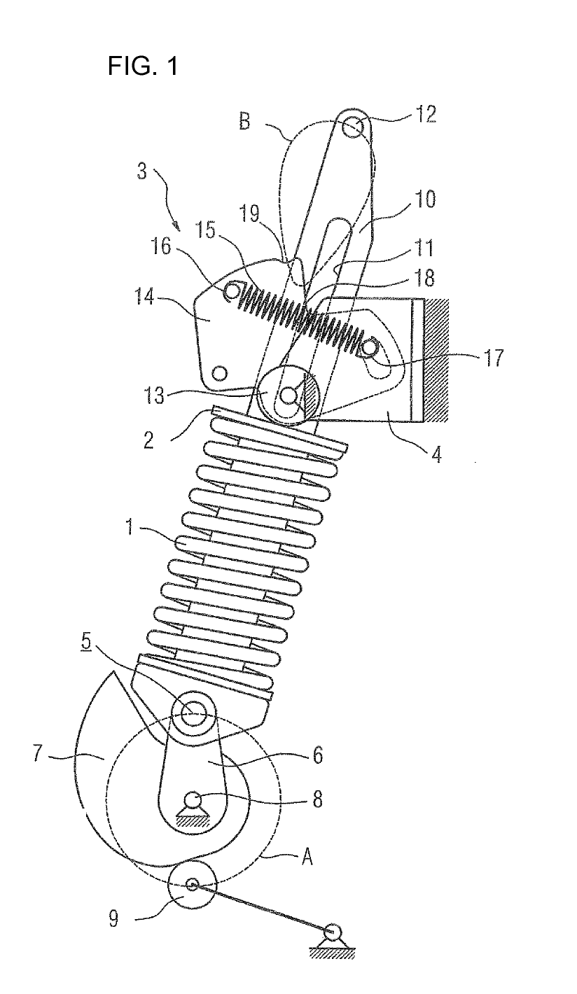

FIG. 1 shows a schematic illustration of a switch-on energy store apparatus in a first position with the switch-on energy store tensioned;

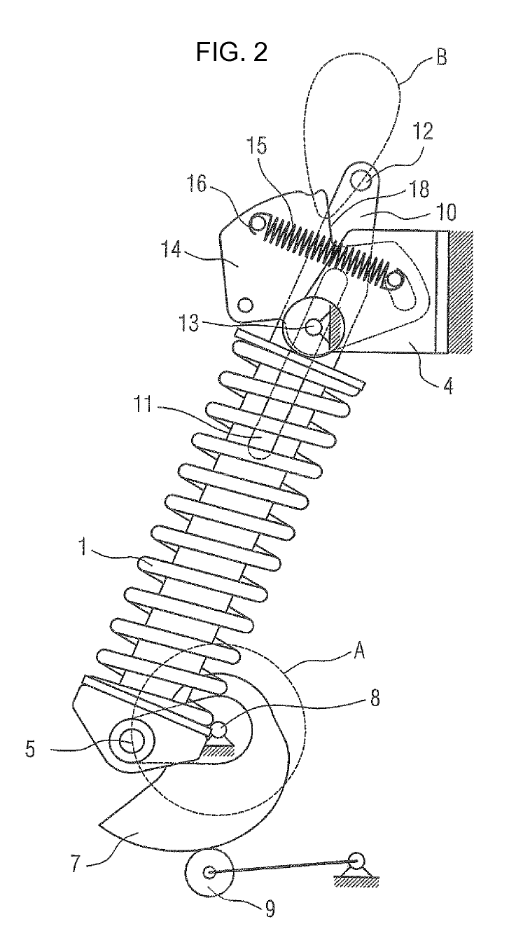

FIG. 2 shows a schematic illustration of the switch-on energy store apparatus in a second position with the switch-on energy store partially relieved of tension;

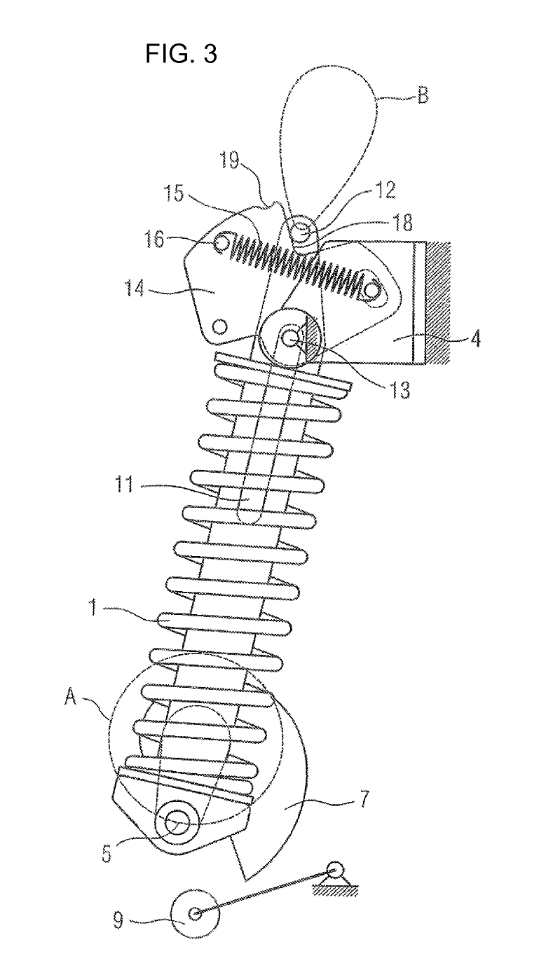

FIG. 3 shows a schematic illustration of the switch-on energy store apparatus in a third position with the switch-on energy store relieved of tension;

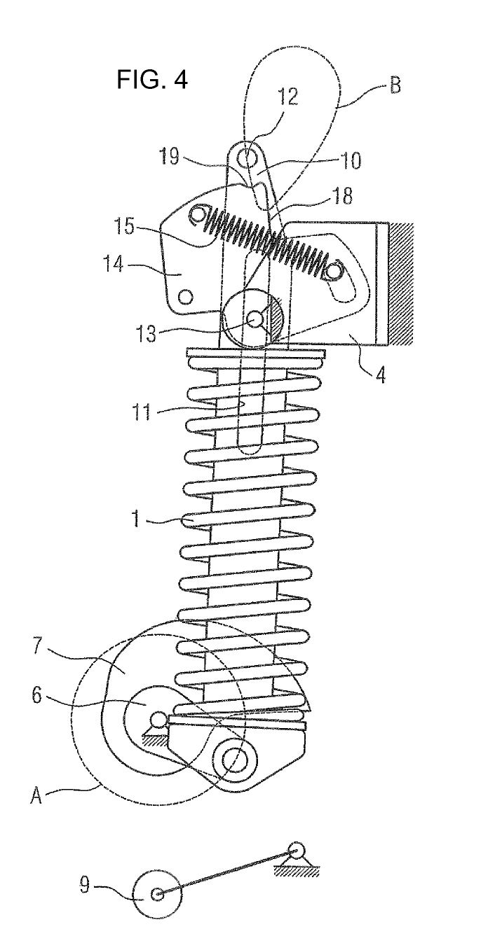

FIG. 4 shows a schematic illustration of the switch-on energy store apparatus in a fourth position; and

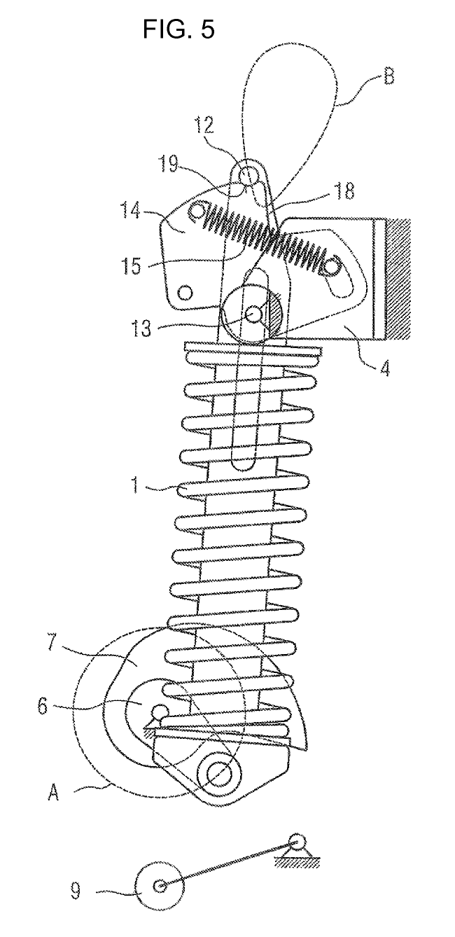

FIG. 5 shows a schematic illustration of the switch-on energy store apparatus in a fifth, locked position.

FIG. 1 shows a switch-on energy store apparatus with a spring element 1 in the form of a switch-on energy store, which is connected at a first end 2 by means of a catch arrangement 3 to a fastening part 4 and at a second end 5 in articulated fashion to an eccentric 6. The eccentric 6 and a cam disk 7 are arranged fixedly on a tensioning shaft 8. The cam disk 7 interacts with a switching shaft 9, which is part of an actuating mechanism (not illustrated) for disconnectable switching contacts of the circuit breaker. A guide part 10 with a slot 11 and a stop element 12 is guided through the first end 2 of the switch-on energy store 1. The guide part 10 is rigidly connected to the second end 5 and is mounted on the fastening part 4 by means of a spindle 13, which extends through the slot 11. The catch arrangement 3 comprises a catch 14, which is likewise mounted rotatably on the spindle 13, and a spring 15, which is fastened at its first end 16 on the catch 14 and at its second end 17 on the fastening part 4. The dashed line A corresponds to the movement path of the second end 5 and the dashed line B corresponds to the movement path of the stop element 12 during a switching or tensioning operation of the switch-on energy store. The movement path B, as a result of the kinematic arrangement of the system, is characterized in that by the fact that, in the event of the movement of the stop element 12 from an upper dead center point to a lower dead center point of the switch-on energy store, a different trajectory is covered than in the reverse movement, as a result of which the latching with the catch 14 is made possible.

In FIG. 1, the switch-on energy store is in a tensioned state, the spring element being under compression strain. The second end 5 is at the upper reversal point of its movement trajectory A, the stop element 12 is located close to the upper bend point of its trajectory B, and the spindle 13 is located at the lower stop of the slot 11 of the guide part 10. The catch 14 is held in a first position by the tensile force of the spring 15.

If a switching operation is triggered, the energy stored in the switch-on energy store is transmitted via the eccentric 6 and the tensioning shaft 8 to the cam disk 7 and, as a result, to the switching shaft 9. In the process, the second end 5 moves along the line A in the counterclockwise direction, and the stop element 12 moves on the line B in the clockwise direction.

FIG. 2 shows the switch-on energy store 1 with the catch mechanism in a position shortly after triggering of a switching operation, the switch-on energy store 1 having been partially relieved of tension. The energy of the switch-on energy store 1 results in a rotation of the cam disk via the tensioning shaft 8 and therefore in a movement of the switch shaft 9. The second end 5 is located in the 9 o'clock position on the line A, while the stop element 12 has moved downward on the line B. The spindle 13 is located in a position close to the second end of the slot 11 relative to the slot 11 as a result of the movement of the guide part 10, which is connected to the second end 5.

FIG. 3 shows the switch-on energy store in a state in which it is completely relieved of tension, in which state the second end 5 and the stop element 12 have reached the lower reversal points of the respective lines A and B. In this position, the spindle 13 is at the upper end of the slot. The stop element 12 bears against the catch 14 in an L-shaped tensioning cutout 18. In this position, the stop element 12 begins to move the rotatably mounted catch 14 counter to the spring force of the spring 15 away from the fastening part 4, the spring 15 being tensioned in the process.

FIG. 4 shows the position of the switch-on energy store 1 and the catch mechanism directly after the switching operation of the circuit breaker. The cam disk 7 is not in contact with the switch shaft 9, and the switching shaft 9 and therefore the contacts of the circuit breaker are in a locked and switched-on position. As a result of the energy of the switch-on energy store 1 which has been converted partially into movement energy during the switching operation, the cam disk 7 and the eccentric 6 rotate beyond their reversal points, the guide part 10 being moved upward and the stop element 12 leaving the tensioning cutout 18 of the catch 14. At this point in time, the catch 14 is moved back into its first position by the tensile force of the spring 15. As a result of the further rotation of the eccentric 6, the switch-on energy store 1 is partially tensioned, as a result of which the switch-on energy store 1 performs a return movement. This return movement is limited by the catch 14, which is moved back into its first position by the spring 15, as is explained with reference to FIG. 5.

FIG. 5 shows the position of the switch-on energy store 1 and the catch mechanism after the switching operation of the circuit breaker with the stop element 12 latched in. The stop element 12 engages in the checking cutout 19 of the catch and is locked. As a result of this locking, a further return of the switch-on energy store 1 is reliably prevented. Therefore, the circuit breaker can be immediately switched off again and a new tensioning operation can take place for the switch-on energy store.

1-6. (canceled)

7. A switch-on energy storage apparatus for a circuit breaker, comprising:
a switch-on energy storage device having a first end and a second end;
an eccentric of a tensioning apparatus connected to said second end of said energy storage device;
return movement-limiting means disposed to interact with said tensioning apparatus, said means including a catch mechanism disposed at said first end of said energy storage device.

8. The apparatus according to claim 7, wherein said means further include a guide part disposed to trigger said catch mechanism, said guide part has a slot formed therein accommodating a fixed spindle, and wherein said first end of said energy storage device is movably mounted on said fixed spindle in said slot, and wherein said guide part is connected to said second end of said energy storage device.

9. The apparatus according to claim 8, wherein said catch mechanism has a catch rotatably mounted about said fixed spindle between a first position and a second position, and wherein a spring element is disposed to act on said catch.

10. The apparatus according to claim 9, which comprises a fastening element holding said fixed spindle and said spring element.

11. The apparatus according to claim 9, which comprises a stop element disposed on said guide part and configured to interact with a tensioning cutout on said catch.

12. The apparatus according to claim 11, wherein said catch is formed with an arresting cutout.
